(19) United States
(12) Patent Application Publication
(10) Pub. No.: US 2007/0188434 A1
(43) Pub. Date: Aug. 16, 2007

(54) APPARATUS FOR DRIVING DISPLAY PANEL

(76) Inventors: Wan-jung Kim, Suwon-si (KR); Dong-chul Park, Suwon-si (KR); Seung-hyun Kim, Suwon-si (KR)

Correspondence Address: F. CHAU & ASSOCIATES, LLC, 130 WOODBURY ROAD, WOODBURY, NY, 11797, US

(21) Appl. No.: 11/675,148

(22) Filed: Feb. 15, 2007

(30) Foreign Application Priority Data
Feb. 15, 2006 (KR) 10-2006-0014739

(51) Int. Cl. G09G 3/36

(52) U.S. Cl. 345/98

(57) ABSTRACT

An apparatus for driving a display panel includes: a memory that stores pixel data to be displayed on the display panel; a multiple line selection (MLS) decoder that receives a plurality of pixel data from the memory and then decodes the plurality of pixel data simultaneousty, and a plurality of column drivers that activate a corresponding plurality of column lines of the display panel in order to output the decoded pixel data to the panel, wherein the MLS decoder is shared by the plurality of column lines. Accordingly, the plurality of column lines shares the MLS decoder and, thus, a chip size can be reduced. Moreover, since the memory outputs the pixel data using a single output line, the memory size can be reduced, as well. Furthermore, the apparatus includes the memory that supports a burst read mode, thereby reducing power consumption.

### CROSS-REFERENCE TO RELATED PATENT APPLICATIONS

This application claims the priority of Korean Patent Application No. 10-2006-0014739, filed on Feb. 15, 2006, in the Korean Intellectual Property Office, the disclosure of which is incorporated herein in its entirety by reference.

### BACKGROUND OF THE INVENTION

1. Technical Field

The present disclosure relates to an apparatus for driving a display panel and, more particularly, to an apparatus for driving a display panel, the apparatus having a plurality of column lines sharing a multiple line selection (MLS) decoder.

2. Discussion of Related Art

Generally, a multiple line selection (MLS) decoder simultaneously decodes three pieces of pixel data stored in a memory. The three pieces of pixel data correspond to pixels of a display panel and the three pixels are located in the same column.

FIG. 1 is a block diagram of an apparatus for driving a display panel according to the prior art. Referring to FIG. 1, the apparatus 10 includes a memory 11, gray scale tables (GSTS) 12, MLS decoders 13, and column drivers 14. According to the prior art, the apparatus 10 has eight MLS decoders 13 that correspond to column lines CLM1 to CLM8 of a display panel 20 respectively. That is, the number of the MLS decoders 13 of the apparatus 10 should be the same as the number of column lines of the display panel 20. In this case, the MLS decoders having the same structure and function as one another are present in a chip. Therefore, the size of the chip is unnecessarily increased.

FIG. 2 is a diagram illustrating the memory 11 used in driving the display 30 panel 20 illustrated in FIG. 1. Referring to FIGS. 1 and 2, the memory 11 stores the pixel data, which are displayed in respective column lines of the display panel 20, in column lines of the memory 11. Whereas a general memory (not shown) includes a single output line DOUT, and the memory 11 used in driving the display panel 20 includes a plurality of output lines SDOUT that correspond to the column lines of the memory, respectively.

The columns of the memory 11, which store a plurality of pixel data, have to be scanned to perform MLS decoding. The memory 11 used in driving the display panel 20 may be an LDIGRAM. The LDIGRAM has to include the plurality of output lines SDOUT and, thus, the size of the memory 11 needs to be increased.

### SUMMARY OF THE INVENTION

Exemplary embodiments of the present invention provides an apparatus for driving a display panel, which reduces the number of MLS decoders and thereby lessens a chip size, and includes a memory that does not need to be scanned and, thus, the chip size and power consumption can be reduced.

Exemplary embodiments of the present invention also provides an apparatus for driving a display panel, which includes a memory supporting a burst read mode, thereby reducing the power consumption.

According to an exemplary embodiment of the present invention, there is provided an apparatus for driving a display panel, the apparatus comprising: a memory, a multiple line selection (MLS) decoder, and a plurality of column drivers.

The memory stores pixel data to be displayed on the display panel. The MLS decoder receives a plurality of pixel data from the memory and then decodes the pixel data simultaneously. The plurality of column drivers activate corresponding column lines of the display panel in order to output the decoded pixel data to the panel.

The MLS decoder is shared by a plurality of the column lines.

The simultaneously decoded pixel data may correspond to pixels that are continuously located in the same column. The number of simultaneously decoded pixel data may be three.

A set of the simultaneously decoded pixel data may form a data set, wherein the MLS decoder decodes a plurality of the data sets sequentially. The apparatus may further comprise: a bus unit that transmits the data sets to the column drivers.

The apparatus may further comprise: a plurality of latch units that respectively latch the corresponding data sets received from the bus unit to transmit the data sets to the column drivers simultaneously.

The apparatus may further comprise: a gray scale table that converts gray scale values of the pixel data stored in the memory into gray scale values that are adapted for the display panel. The gray scale table may be shared by the plurality of column lines.

The memory may output the pixel data using a single output line. The memory may be a single port static RAM (SPSRAM), and the apparatus may be a super twisted nematic-LCD driver IC (STN-LDI),

According to an exemplary embodiment of the present invention, there is provided an apparatus for driving a display panel, the apparatus comprising: a memory an MLS decoder, and a plurality of column drivers.

The memory stores pixel data displayed on the display panel. The multiple line selection (MLS) decoder receives a plurality of pixel data from the memory and then decodes the pixel data simultaneously. The plurality of column drivers activate corresponding column lines of the display panel in order to output the decoded pixel data to the panel. The memory stores the pixel data, which will be transmitted to the MLS decoder and decoded simultaneously, in the same row line of the memory.

The MLS decoder may be shared by a plurality of the column lines. The simultaneously decoded pixel data may correspond to pixels that are continuously located in the same column. The number of simultaneously decoded pixel data may be three.

The memory may support a burst read mode that outputs the plurality of pixel data simultaneously. The MLS decoder may receive the pixel data according to the burst read mode. A set of the simultaneously decoded pixel data may form a data set, wherein the MLS decoder decodes a plurality of the sets sequentially.

The apparatus may further comprise: gray scale tables that convert gray scale values of the pixel data stored in the memory into gray scale values that are adapted for the display panel. The number of gray scale tables may be the same as the number of pixel data.

### BRIEF DESCRIPTION OF THE DRAWINGS

Exemplary embodiments of the present invention will be understood in more detail from the following descriptions taken in conjunction with the attached drawings in which:

FIG. 1 is a block diagram illustrating an apparatus for driving a display panel according to the prior art;

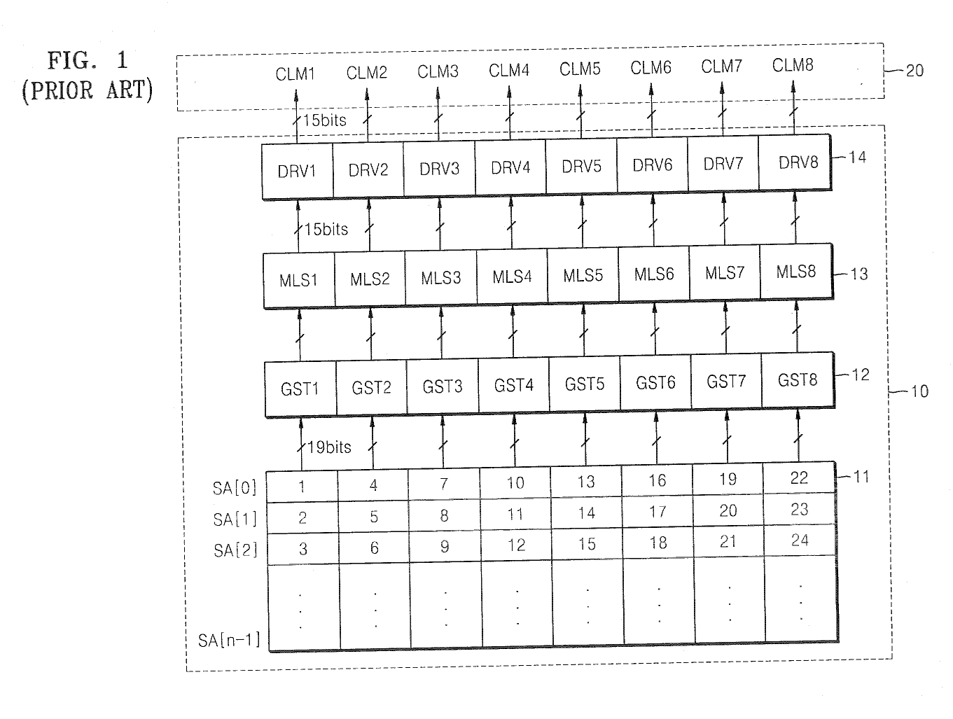

FIG. 2 is a diagram illustrating a memory of the apparatus illustrated in is FIG. 1;

FIG. 3 is a block diagram illustrating an apparatus for driving a display panel according to an exemplary embodiment of the present invention; and

FIG. 4 is a block diagram illustrating an apparatus for driving a display panel according to an exemplary embodiment of the present invention.

### DETAILED DESCRIPTION OF EXEMPLARY EMBODIMENTS

The present invention will now be described more fully with reference to the accompanying drawings, in which exemplary embodiments of the invention are shown. Throughout the drawings, like reference numerals are used to refer to like elements.

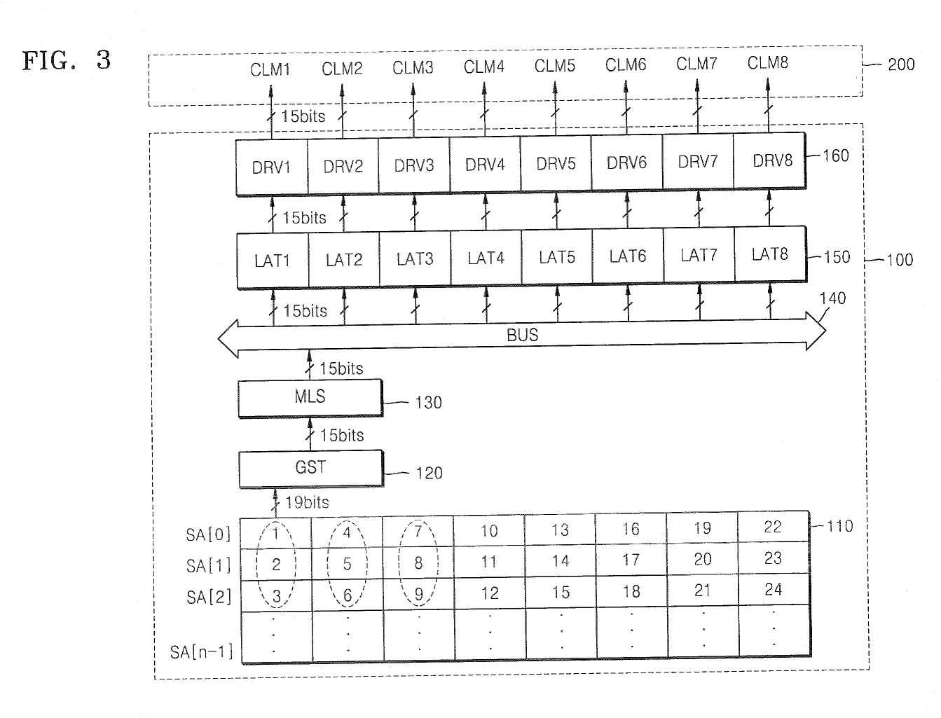

FIG. 3 is a block diagram illustrating an apparatus 100 for driving a display panel 200 according to an exemplary embodiment of the present invention. Referring to FIG. 3, the apparatus 100 for driving a display panel includes a memory 110, a multiple line selection (MLS) decoder 130, and a plurality of column drivers 160.

The apparatus 100 may be a super twisted nematic-LCD driver IC (STN-LDI).

The memory 110 stores pixel data to be displayed in respective corresponding pixels of the display panel 200. The memory 110 according to the exemplary embodiment stores the entire picture that will be displayed in the display panel 200.

More specifically, the pixel data stored in a first position of the memory 110 is displayed in a first pixel of the display panel 200, and the pixel data stored in a second position of the memory 110 is displayed in a second pixel.

The MLS decoder 130 is shared by the plurality of column lines. FIG. 3 illustrates the MLS decoder 130 which is shared by the eight column lines CLM1-CLM8. Therefore, unlike the LDIGRAM that is the conventional memory for driving a display panel, the memory 110 can output the pixel data using a single output line, In this exemplary embodiment, the memory 110 may be a single port static RAM (SPSRAM).

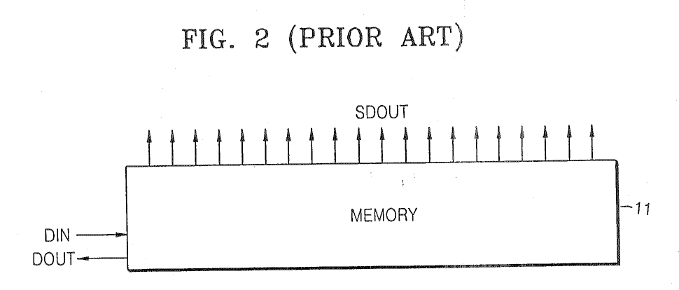

In other words, the memory 110 can output the pixel data through the single output line DOUT without having a plurality of output lines SDOUT corresponding to respective columns as in the prior art memory 11 shown in FIG. 2.

On the other hand, the memory 110 could be an LDIGRAM that includes a plurality of conventional output lines, but for a reduction in memory size, an SPSRAM is more efficient.

The MLS decoder 130 receives a plurality of pixel data from among all the pixel data and decodes them simultaneously. In this exemplary embodiment the plurality of pixel data are three pieces of pixel data corresponding to a plurality of pixels that are adjacent to one of the column lines CLM1 to CLM 8 of the display panel 200.

The MLS decoder 130 operates sequentially on the column lines CLM1 to CLM8, which share the MLS decoder 130, and decodes the data sets. More specifically, the MLS decoder 130 decodes a first data set 1, 2, and 3, which are output to a first column line CLML, and then decodes a second data set 4, 5, and 6, which are output to a second column line CLM2. The MLS decoder 130 continues in the same fashion, until the MLS decoder 130 decodes an eighth data set 22, 23, and 24, which are output to a eighth column line CLM8.

After the decoding of the data sets corresponding to three row lines SA[0], SA[1], and SA[2] of the display panel is completed, the MLS decoder 130 repeatedly decodes the data sets corresponded to the next three row lines SA[3], SA[4], and SA[5] (not shown).

The apparatus 100 further includes a bus unit 140 for transmitting sets of pixel data corresponding to column lines, which have been decoded at different times, through respective latches of the latch unit 150 to the corresponding column drivers 160.

The column drivers 160 output the data sets, which are displayed in three row lines of the display panel, simultaneously. Therefore, the apparatus 100 further includes the latch unit 150. The plurality of column drivers 160 activate the corresponding column lines of the display panel 200 in order to output the decoded pixel data to the pixels.

The latch unit 150 receives the decoded pixel data from the bus unit 140 and transmits them to the corresponding drivers DRV1-DRV8 of the column driver 160. The latch unit 150 latches the pixel data 1 to 21 until the last pixel data 22, 23, and 24, which are output to the eighth column line CLM8, are decoded and then transmitted to the corresponding driver DRV8 of the column driver 160.

Referring to FIG. 3, the apparatus 100 further includes a gray scale table 120 (GST). The GST 120 converts the gray scale values of the pixel data stored in the memory 110 to gray scale values adapted for the display panel 200. The GST 120 may be shared by the column lines CLM1 to CLMS of the display panel.

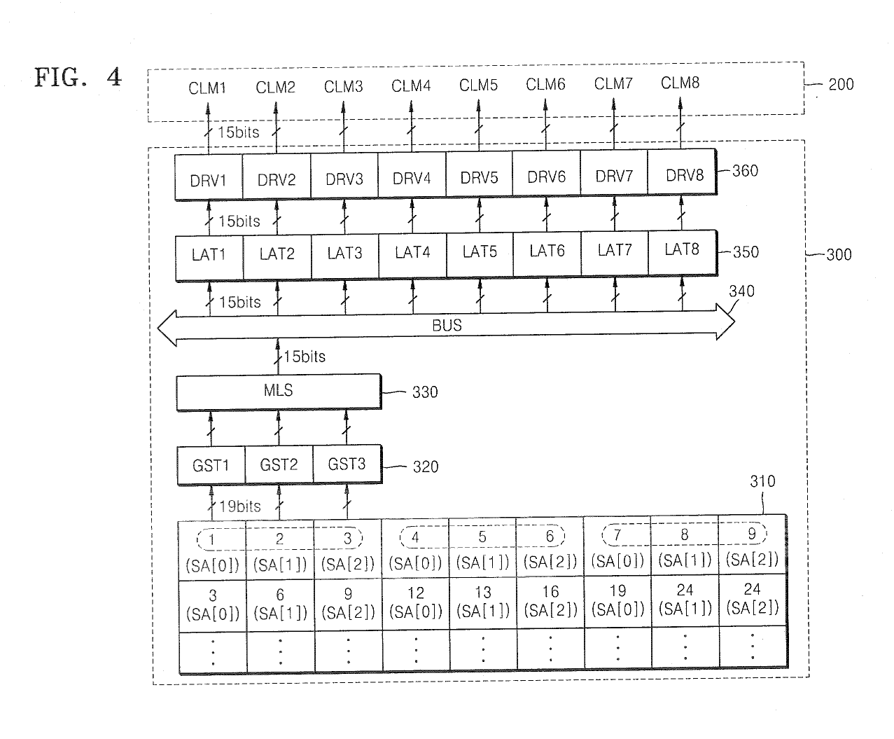

FIG. 4 is a block diagram illustrating an apparatus 300 for driving a display panel 200 according to an exemplary embodiment of the present invention. Referring to FIG. 4, the apparatus 300 includes a memory 310, a MLS decoder 330, and a plurality of column drivers 360.

The operations of the MLS decoder 330 and the column drivers 360 are the same as those illustrated in FIG. 3, however, the apparatus 300 illustrated in FIG. 4 includes a memory 310 that is different from that of the apparatus 100 illustrated in FIG. 3.

The memory 310 stores a plurality of pixel data, which will be transmitted to the MLS decoder 330 and decoded simultaneously, in a row of the memory 310. In other words, the pixel data, which will be output to the same column and decoded simultaneously, are stored in the same row of the memory 310.

The memory 310 illustrated in FIG. 4 stores a set of pixel data 1, 2, and 3 which are output to a first column line CLM1 of the display panel 200 in the same row line of the memory 310. In the same manner, the memory 310 stores a set of pixel data 4, 5, and 6 which are output to a second column line CLM2 of the display panel 200 in the same row line of the memory 310.

Thus, the memory 310 supports a burst read mode that allows the set of pixel data, that is, three pieces of pixel data, to be output from the memory 310 simultaneously. The MLS decoder 330 receives the pixel data according to the burst read mode.

In this exemplary embodiment, the number of GSTs that can be included in the apparatus 300 may be as many as the number of the pixel data that are transmitted according to the bust read mode. Therefore, the apparatus 300 illustrated in FIG. 4 includes three GSTs, that is, GST1 to GST3.

The GSTs GST1 to GST3 convert gray scale values of the set of pixel data 1, 2, and 3, which are output to the first column line CLM1 to gray scale values adapted for the display panel 200. In the same manner, the GSTs GST1 to GST3 convert gray scale values of the set of pixel data 4, 5, and 6, which are output to the second column line CLM2 to gray scale values adapted for the display panel 200.

The MLS decoder 330 does not need to latch the pixel data because it can receive the plurality of pixel data simultaneously using the three GSTs GST1 to GST3.

Therefore, since the memory 310 illustrated in FIG. 4 supports the burst read mode, the apparatus 300 lowers the frequency bandwidth of the memory to one third of the frequency bandwidth of the memory of the apparatus 100 illustrated in FIG. 3.

According to exemplary embodiments of the present invention, an apparatus for driving a display panel includes an MLS decoder that is shared by a plurality of column lines and, thus, the chip size can be reduced. Moreover, since the apparatus can be driven using a memory having only a single output line, the memory size can be reduced as well. Furthermore the apparatus includes a memory supporting a burst read modes thereby reducing power consumption.

While the present invention has been particularly shown and described with reference to exemplary embodiments thereof it will be understood by those of ordinary skill in the art that various changes in form and details may be made therein without departing from the spirit and scope of the present invention as defined by the following claims.

What is claimed is:

1. An apparatus for driving a display panel, the apparatus comprising:
a memory that stores pixel data to be displayed on the display panel;
a multiple line selection (MLS) decoder that receives a plurality of pixel data from the memory and decodes the received pixel data simultaneously; and
a plurality of column drivers that activate a corresponding plurality of column lines of the display panel in order to output the decoded pixel data to the display panel,
wherein the MLS decoder is shared by the plurality of column lines.

2. The apparatus of claim 1, wherein the simultaneously decoded pixel data correspond to pixels that are continuously located in the same column.

3. The apparatus of claim 2, wherein three pixel data are simultaneously decoded.

4. The apparatus of claim 2, wherein a set of the simultaneously decoded pixel data forms a data set, and the MLS decoder decodes the data sets sequentially.

5. The apparatus of claim 4, further comprising:
a bus unit that transmits the data sets to the plurality of column drivers.

6. The apparatus of claim 5, further comprising:
a plurality of latch units that respectively latch the corresponding data sets received from the bus unit to transmit the data sets to the plurality of column drivers simultaneousty.

7. The apparatus of claim 1, further comprising:
a gray scale table that converts gray scale values of the pixel data stored in the memory into gray scale values adapted for the display panel.

8. The apparatus of claim 7, wherein the gray scale table is shared by the plurality of column lines.

9. The apparatus of claim 1, wherein the memory outputs the stored pixel data using a single output line.

10. The apparatus of claim 9, wherein the memory is a single port static RAM (SPSRAM).

11. The apparatus of claim 1, wherein the apparatus is a super twisted nematic-LCD driver IC (STN-LDI).

12. An apparatus for driving a display panel, the apparatus comprising:
a memory that stores pixel data displayed on the display panel;
a multiple line selection (MLS) decoder that receives a plurality of pixel data from the memory and decodes the received pixel data simultaneously; and
a plurality of column drivers that activate a corresponding plurality of column lines of the display panel in order to output the decoded pixel data to the display panel,
wherein the memory stores the pixel data, which will be transmitted to the MLS decoder and decoded simultaneously, in a same row line of the memory.

13. The apparatus of claim 12, wherein the MLS decoder is shared by the plurality of column lines.

14. The apparatus of claim 13, wherein the simultaneously decoded pixel data correspond to pixels that are continuously located in the same column.

15. The apparatus of claim 14, wherein three pixel data are simultaneously decoded.

16. The apparatus of claim 14, wherein the memory supports a burst read mode that outputs the plurality of pixel data simultaneously.

17. The apparatus of claim 16, wherein the MLS decoder receives the pixel data according to the burst read mode.

18. The apparatus of claim 2, wherein a set of the simultaneously decoded pixel data forms a data set, and the MLS decoder decodes the data sets sequentially.

19. The apparatus of claim 13, further comprising:
gray scale tables that convert gray scale values of the pixel data stored in the memory into gray scale values adapted for the display panel.

20. The apparatus of claim 19, wherein a number of the gray scale tables is the same as a number of the pixel data.
